(19) United States
(12) Patent Application Publication
(10) Pub. No.: US 2019/0130507 A1
(43) Pub. Date: May 2, 2019

(54) Systems and Methods for Monetizing Intellectual Property

(71) Applicant: Jeff Stollman, Wayne, PA (US)

(72) Inventor: Jeff Stollman, Wayne, PA (US)

(21) Appl. No.: 15/796,069

(22) Filed: Oct. 27, 2017

(51) Int. Cl. G06Q 50/18; G06Q 30/02; H04L 9/06

(52) U.S. Cl. CPC G06Q 50/184; G06Q 30/0283; H04L 2209/56; G06Q 2220/00; H04L 9/0637

(57) ABSTRACT

Systems and methods for creating and issuing specialized cryptocurrencies or tokens to be used as a medium of exchange that innovators may use to monetize their innovation, allowing them to fund development and bring their innovation to market, are disclosed. The methods for creating, issuing and selling the cryptocurrency uses a computing infrastructure, such as a blockchain, that incorporates a transaction record comprising a plurality of linked transactions utilizing cryptographic techniques that will expose any attempts to alter, or any alterations of the plurality of previously linked transactions. In addition to technology innovations, the disclosed systems and methods are equally applicable for use by artists, such as musicians or filmmakers seeking to fund development of their creative works using a token offering that requires the tokens to be used as the form of payment to leverage (including access, purchase, license, or other use of) the developed creative work.

### FIELD OF THE INVENTION

The present invention generally relates to the field of systems and methods for funding the commercialization of innovations, with specific use of blockchain cryptocurrency and token technology to facilitate early-stage funding of development and marketing efforts to bring products and services to market. More particularly, the disclosed embodiments provide systems and methods that may be used to create and issue cryptocurrency tokens as a monetization mechanism and medium to be specifically used to raise funds to assist in the development and commercialization of innovative intellectual property (IP). In a specific embodiment, the described methods and systems may be used to raise funds in the early stages or phases of development and commercialization of a technology when such funding is most critically needed to spur innovation development. The cryptocurrency or token creation and issuance may include the sale of innovation futures, and/or the use of frameworks such as Initial Coin Offerings (ICOs) and the Simple Agreement for Future Tokens (https://saftproject.com/#saft-whitepaper), with direct application of such elements to a particular innovation or group of innovations. These frameworks enable innovators to raise money early in their development/marketing efforts in order to augment funding of their projects.

### BACKGROUND DESCRIPTION AND REVIEW OF CERTAIN PRIOR ART

Innovations, especially technical innovations, have long been stifled by the difficult road of bringing such innovations to market. Inventors and innovators who develop novel ideas often find themselves with the difficult task of obtaining necessary financing in the critical early stages of the innovation development cycle. Depending on their familial connections, marketing skills, as well as their geographic location, some “lucky” innovators may be able to raise funding from friends, family, and connections, angel groups, private equity firms, and/or venture-capital investors with most innovators often giving up significant equity in the business or ownership in the innovation in exchange for such funding.

For many innovators, including those located outside of traditional investment or technology centers such as Silicon Valley, London, N.Y., and Singapore, the needed capital is never able to be obtained—even where a substantial dilution of the innovator's equity is available and offered. Indeed, for many inventors and innovators, their creative ideas and inventions never make it through development or to market. One data metric relevant to this issue is that, according to Forbes, 95% of US patents are never licensed or commercialized. (https://www.forbes.com/sites/danielfisher/2014/06/18/13633).

This problem is well recognized. Indeed, a primary and recurring impediment faced by most innovators is the need to obtain sufficient early stage funding to traverse the “Chasm of Commercialization,” defined as the period between conceptualization of the innovation and the breakeven point in the sales cycles. This period generally entails the design and development of a minimum viable product and improvements thereto, and often includes prototyping, proofs of concept, pilots, and marketing of the innovation and business model to both customers and prospective financiers.

Some of the barriers and costs faced by early stage innovators during the “Chasm of Commercialization” include intellectual property protection costs, technology development and testing costs, demonstration costs, marketing, and initial production costs. The following provides further color and detail relating to each of these expense categories.

Intellectual Property (IP) Protection. One of the most common ways to protect the IP of an innovation is through patent filings covering embodiments of the invention. Developing an effective patent application that addresses the various requirements of a particular patent office is a specialized skill. To obtain such IP protection often requires hiring specialized resources, such as patent attorneys and patent search firms, each who have specialized skills and expertise, and usually command high service fees.

After an application is filed, where the filing fees are typically nominal, even well-written applications are required to go through one or more rounds of review and prosecution with the respective patent offices. The service fees for above noted experts to assist during the prosecution of the applications often dwarf the cost of drafting and filing the initial application. Moreover, seeking and obtaining patent protection in more than one country requires further filing fees and prosecution costs on a country-by-country basis. Such international costs and fees potentially increases the overall cost of obtaining patent protection by at least an order of magnitude. Further, after the grant of a patent, there are on-going maintenance fees or annuity payments necessary to maintain the patent validity, which further increases IP protection costs.

Even where a patent is finally granted, well-funded competitors may seek to challenge the patent grant through various legal or judicial processes, including inter partes review, or post grant reviews, or interference actions, each as provided under United States law. Those inventors and innovators with limited financial wherewithal may have no or limited ability to effectively defend their granted patents against companies and law firms with deep experience in challenging patents. After patent grant, and potential post grant challenges, the innovator may still need his own “war chest” to fend off intentional or innocent infringers using or copying the innovators patented ideas. Unfortunately, there are intentional infringers who are well aware that if the innovator has insufficient financial resources, the innovator will not be able to enforce his or her patent rights in court against the infringer.

As Forbes notes, “Requiring a federal judge, as we now do, to determine exactly what each and every patent covers is a very expensive way to do business. That may work for a few deep-pocketed companies, but the multi-million dollar cost of asserting or defending a lawsuit effectively freezes out most patent owners and users. It also defeats the purpose of America's patent system, which, uniquely among all nations prior to its creation, was designed to stimulate the ingenuity of the common man.”

Development costs. Having an innovative idea and protecting it with a patent is but one step of many to bring a product to market. The innovator typically needs to develop a prototype or proof of concept of the innovation, and the test or pilot the innovation to show customers and the market that the innovation works and will address the customers' pain points. For hardware, this may involve design, tooling, molding, machining, assembly, and testing costs. For software, this may require architecture, detailed design, programming, infrastructure (such as design tools and the creation of multiple application environments for development, test, and production), data development, and testing costs.

Demonstration costs. The costs of bringing in prospective customers to witness the operation of the innovation, in particular physical sciences or hardware innovations, typically includes setting up a demonstration (prototype demonstration, proof of concept, pilot demonstration), in order to show customers of the viability and operation of the innovation. Such costs are often substantial.

Marketing costs. Further along the development and commercialization cycle, marketing costs are necessary and may include market research, prospect identification, and sales calls. Innovators typically face these costs up-front. That is, such costs need to be incurred before the innovator has a reasoned prospect of receiving revenue for the innovation.

Production costs. Some product innovations require the manufacturing of a sufficient initial inventory or product to be able to meet orders. Under typical payment scenarios where the producer is paid only after delivery, it may necessary to buy raw materials and manufacturing equipment, hire staff, and to lease manufacturing and warehousing space to create the necessary quantities to create the saleable products. In service businesses, it may also be necessary to buy equipment, hire and train staff, and lease space to deliver and support the service.

These five categories of costs, in addition to other costs creates a rather steep wall, at the outset of the commercialization process, that is a primary reason that “95 percent [of all patented technologies] fail to be licensed or commercialized.”

One solution to overcoming this initial financial hurdle faced by innovators is through venture capital. Venture capitalists (VCs) often fund early stage innovators and businesses to help them bring their ideas and innovations into commercial use. In exchange for their provision of early stage capital, VCs generally require assignment of a large share of the equity of the innovation or business.

There is good reason for VCs to be highly selective about the innovations and innovators they support. VC firms are comprised of people with various areas of expertise. Each firm focuses on innovations that they understand and/or have experience working with, including an understanding of the particular business and innovation risks, such as pharmaceutical drug development and commercialization, or medical device development and commercialization. With only a small number of firms in the business most of which have only a handful of experts evaluating candidate innovations, VCs are understandably selective of the innovations to support. Moreover, as an additional way to reduce risk for the VC firm, funding tends to favor innovators who have already experienced prior success. VC funding often takes on the appearance of a club which many innovators are not qualified to join. Even innovators willing to swallow the bitter pill of significant equity dilution have difficulty attracting respected venture capital. Accordingly, VC investment is not a readily accessible resource for the vast majority of innovators.

Society puts increasing emphasis on innovation, especially technology innovations, as a means to both address and solve the myriad of society's problems and to improve our lives. But to facilitate the development of such innovations, and to then bring those innovations to market often requires money. And the current difficulties faced by many innovators in obtaining this money only serves to limit the ability of innovators to effectively address the many existing (and future) problems and pain points. In recognition of this funding issue, governments have implemented various programs to incentivize and support innovators, such as Small Business Innovation Research (SBIR) phased grants in the US, and Horizon 2020 (for SMEs—small, medium sized enterprises) within the European Union. Further, various private groups, such as incubators and accelerators, exist to provide particular startup business support for and to spur along worthy innovations. But most innovators continue to struggle in their efforts to overcome the steep financial barriers that stand in the way of developing, testing, and then bringing their ideas to market.

The present invention is designed to leverage the inexpensive creation of cryptocurrency tokens as a method to provide innovators with needed early stage capital to successfully traverse the “Chasm of Commercialization.” Through collection and use of this capital, some innovations may be successfully commercialized, where without such capital and access to financiers, the innovation would never to make it to the market and help customers. For other innovators, the ready access to significant capital will likely help to expedite the development and commercialization of the innovation. An important aspect of the methods and systems disclosed is that the innovator may not need to substantially dilute or transfer his or her equity thereby allowing the innovator to more directly and fully benefit from the developed innovation. Furthermore, by bringing more innovations to market and by bringing such innovations to market more rapidly, society directly benefits from the availability of these innovative products and services.

An underlying component of the disclosed inventive methods and systems used to fund early stage innovation commercialization is the same system that underlies cryptocurrencies such as Bitcoin, Ethereum, and STEEM. Instead of focusing on the currency value of the coin or token, with the disclosed invention, the innovator uses the coin or token as a medium of exchange explicitly to be used for the payment of fees for leveraging the underlying technology being developed.

The concept of issuing tokens is distinct from a standard securities Initial Public Offering (IPO). In an IPO, a company issues shares of ownership (equity or stock) in the company to the public. By contrast, the issued tokens are not created as ownership or equity in any company, and sales of tokens do not need to offer equity in any constituent business structure. More particularly, the token value can be unrelated to the value of the issuer of the tokens. Instead, the token value is based solely on the supply of tokens and demand by users or licensees to procure tokens in order to pay for access to the innovation, or to pay necessary license fees.

The offering of tokens is not new. The first token offering was an Initial Coin Offering (ICO) by Mastercoin in 2013. (https://en.wikipedia.org/wiki/Initial coin offering). The tokens issued by Mastercoin were created and used as a new cryptocurrency. When the tokens being offered for sale serve as cryptocurrencies, the tokens are generally referred to as “coins,” and the offering is commonly referred to as an ICO.

The next year, the Ethereum Foundation issued the second token offering. The Ethereum tokens issued in 2014 also served as a cryptocurrency. But the Foundation also retained a certain amount of the tokens internally to fund internal development of the Ethereum protocol. Since that time hundreds of additional ICOs have been used to launch hundreds of cryptocurrencies.

More recently, some token sales have been used to raise equity in new businesses. (https://qz.com/1004892/the-bancor-ico-just-raised-153-million-on-ethereum-in-three-hours). Other token creation and sales are used to buy products or services from the token issuer. E.g., for the Storjcoin offering, tokens sold can be sued to obtain cloud-based data storage. (https://cointelegraph.com/explained/ico-explained). To date, there do not appear to be any token offerings that have targeted the use of the tokens as a means for direct payment of leverage fees for innovative products and/or services.

The raising of funding typically starts when the innovator first creates a token offering, often called an Initial Coin Offering or a Token Generating Event (TGE). The tokens are commonly just ledger entries in a blockchain such as Ethereum that indicate that in exchange for some payment (of fiat currency or cryptocurrency) the payer has been assigned a certain number of tokens (which may include partial tokens). The innovator assigns to these tokens certain rights that are valued by prospective buyers. For example, the token may be exchangeable for leverage of (e.g., have access to, use of, license of, or purchase of) the innovation, or they may take on a value as a general purpose store of value. In fact, the innovator may require the use of tokens as the sole medium of exchange with which to obtain leverage of his innovation. This limitation on usage may enhance the token's value. In some cases, the products or services will only become available at a future date after the innovator has used the funds to develop his product into a product or service. In some offerings the tokens are not issued until the product of service is available for leveraging.

As part of the ICO, the tokens are offered for sale to a plurality of prospective buyers. The innovator is then able to use the proceeds of the ICO to fund the on-going development and marketing of the innovation. Because leveraging of the innovation requires tokens as the medium of exchange for such access, this market restriction may increase the demand for the tokens by those seeking to leverage the innovation who need tokens for such access. This demand often fosters the development of a secondary market that allows the issued tokens to be bought and sold by those interested in leveraging the innovation. The innovator may also reserve a portion of the tokens to reward himself and other early team members who invested “sweat equity” prior to the token raising effort.

In another example of the usefulness of this approach, artists (e.g., musicians, filmmakers, sculptors of large projects) may fund the development of their artworks with tokens and then require the tokens as the form of payment to license access to their resulting creative works.

Entities who buy the tokens may include licensees or purchasers needing the tokens to pay required leveraging fees. Alternatively, some entities may be investors or speculators predicting that, as the popularity of the innovation increases, demand for the tokens needed to pay fees will also increase, and thus the value of the tokens, may increase. In other words, if the innovation is perceived by the public to be valuable enough, the demand for the tokens needed to pay for leveraging the innovation may drive up the price for the limited number of tokens in the market. The potential for the price of the tokens to increase may also drive further demand for the tokens by investors and speculators interested in the potential for the price of the tokens to continue to rise as the market for the innovation continues to grow.

A similar approach to this type of a system has been, in part, successfully performed by the Ethereum Foundation. (https://qz.com/1004892/the-bancor-ico-just-raised-153-million-on-ethereum-in-three-hours). Unlike the present invention, the Ethereum Foundation created Ether a cryptocurrency used as an alternative to fiat currency. As noted, the Ethereum Foundation also reserved some of the currency to fund internal operations of bringing the Ethereum platform to market.

The present invention is distinguished from the Ethereum model and system because, as noted, the created tokens are not created as a cryptocurrency. More particularly, the created tokens have no value except as a medium of exchange for leveraging the underlying technology innovation. No attempt may be made to use them for transactions other than the payment of the specific leverage fees that they were created to address.

As described above, while systems have been created that address the creation of tokens or ICOs, none of the known systems provide the ability to create a general platform for the monetization of future leverage fees by innovators in need of early-stage capital to commercialize their creative ideas. Various embodiments of the current systems and methodologies disclosed herein provide a complete solution to the noted issues and problems.

### SUMMARY OF THE INVENTION

The present invention overcomes the disadvantages of the prior art and fulfills the needs described above by providing systems and methods for creating token offerings in which the demand for tokens is at least partially correlated to the demand of buyers to leverage the product or service covered by the token. In some embodiments, the product or service may already be available for leveraging at the time of the offering.

A preferred embodiment of the invention is a method for issuing tokens that serve as a mechanism to pay leverage fees to an innovator for leveraging an innovation. The innovation may be a product such as a novel mousetrap or a service such as a methodology and system to proactively detect counterfeit goods in a supply chain, or any creative work such as a musical composition or choreographic presentation.

Another embodiment of the invention is a method for monetizing intellectual property archetypes created by at least one innovator, wherein said method operates through an innovator-tier computing platform, further wherein said monetization entails creation, sale, and accounting of cryptographic tokens using a computer infrastructure incorporating a transaction record comprising a plurality of linked transactions that utilize cryptographic techniques that expose attempts to alter, or alterations of, any of said plurality of previously linked transactions, and further wherein said innovator-tier computing platform operates a non-transitory machine-readable medium comprising the steps of (a) creating a set of guidelines to structure and operate said innovator-tier computing platform to provide at least one entity with the ability to leverage at least a portion of said IP archetype, said set of guidelines comprising (i) a first set of procedures for registering and enrolling said at least one entity seeking to implement at least one embodiment of said IP archetype; (ii) a second set of procedures for confirming and documenting an agreement by said at least one entity to a set of terms and conditions provided by said innovator tier computing platform; (iii) a third set of procedures for creating a plurality of tokens serving as a medium of exchange to leverage said IP archetype; and (iv) a fourth set of procedures for managing said innovator tier computing platform; (b) enrolling at least one entity seeking to leverage at least a portion of said IP archetype; (c) creating a plurality of cryptographic tokens to commercialize said IP archetype, wherein said cryptographic tokens may be exchanged for leverage of said IP archetype; and (d) collecting said cryptographic tokens from said at least one entity in exchange for providing leverage of said IP archetype; wherein said monetization of said IP archetype is realized through said creation, sale, transfer, collection, and accounting of said cryptographic tokens in exchange for providing leverage of said IP archetype, and wherein said monetization uses said integrator-tier computing platform incorporating a transaction record comprising a plurality of linked transactions that utilize cryptographic techniques that expose attempts to alter, or alterations of, any of said plurality of previously linked transactions.

A further embodiment of the invention is a two-tier method for monetizing intellectual property archetypes that are created by at least one innovator, wherein at least one said buyer of tokens is a solution provider who establishes his own solution that leverages the innovation. In such an embodiment, the solution may incorporate a smart contract that pays tokens to the innovator based upon metrics calculated by the smart contract and used as a basis for establishing fees for leveraging the innovation. Such metrics may include one or more of at least the number of clients, number of transactions, and/or value of transactions.

Another embodiment of the invention is a system for monetizing at least one intellectual property archetypes created by at least one innovator, wherein said monetization entails creation, sale, and accounting of cryptographic tokens using a computer infrastructure incorporating a transaction record comprising a plurality of linked transactions that utilize cryptographic techniques that expose attempts to alter, or alterations of, any of said plurality of previously linked transactions, said system comprising:
A. at least one innovator tier computing platform comprising at least one computer server executing non-transitory machine-readable code undertaking the steps of (a) creating a set of guidelines to structure and operate said innovator-tier computing platform to provide at least one entity with the ability to leverage at least a portion of said IP archetype, said set of guidelines comprising (i) a first set of procedures for registering and enrolling said at least one entity seeking to implement at least one embodiment of said IP archetype; (ii) a second set of procedures for confirming and documenting an agreement by said at least one entity to a set of terms and conditions provided by said innovator tier computing platform; (iii) a third set of procedures for creating a plurality of tokens serving as a medium of exchange to leverage said IP archetype; and (iv) a fourth set of procedures for managing said innovator tier computing platform; (b) enrolling at least one entity seeking to leverage at least a portion of said IP archetype; (c) creating a plurality of cryptographic tokens to commercialize said IP archetype, wherein said cryptographic tokens may be exchanged for leverage of said IP archetype; and (d) collecting said cryptographic tokens from said at least one entity in exchange for providing leverage of said IP archetype;
B. at least one transaction server executing non-transitory machine-readable code operating an blockchain to record said cryptographic token transactions;
C. a communications network to which said at least one computer server and said transaction server are communicatively connected; and
D. a plurality of end user computing devices communicatively connected to said communications network.

### BRIEF DESCRIPTION OF THE DRAWINGS

For the purposes of illustrating the invention, the attached drawings show certain aspects and embodiments that are presently preferred. However, it should be understood that the invention is not limited to the precise methodology or process steps or system elements as shown in the accompanying drawings, but rather is further disclosed and claimed according to the attached claims.

FIG. 1A is an illustrative process-flow diagram of a standard innovation development cycle, absent any equity funding;

FIG. 1B is an illustrative process-flow diagram of an innovation development cycle that includes an embodiment incorporating token creation and issuance;

FIG. 2A is an illustrative bar graph of an innovator's cash flow for a standard development cycle, absent any equity funding;

FIG. 2B is an illustrative bar graph of an innovator's cash flow for an innovation development cycle that includes an embodiment incorporating token creation and issuance;

FIG. 3 is an illustrative process-flow diagram of an embodiment of methodology steps to develop a token offering;

FIG. 4 is an illustrative process-flow diagram of an embodiment of methodology steps to issue and sell tokens through an offering process;

FIG. 5 is an illustrative system element diagram showing the core system components of an embodiment of the present invention;

FIG. 6 is an illustrative system element diagram showing certain system components used as part of the leveraging process;

FIG. 7 is an illustrative process-flow diagram depicting the additional steps in providing a platform to automate and standardize the onboarding of solution providers seeking to leverage the innovation in their own solution offering;

FIG. 8 is an illustrative block diagram depicting the additional system components in a platform embodiment;

FIG. 9 is an illustrative process-flow diagram depicting a platform designed to automat; and standardize the development of a standardized platform for multiple innovators;

FIG. 10 is an illustrative block diagram depicting the additional system components in a platform embodiment with multiple innovator tiers, and multiple solution provider tiers; and

FIG. 11 is an illustrative block diagram depicting the additional system components in a platform embodiment with a master tier and multiple innovator tiers solution-provider tiers.

### DETAILED DESCRIPTION OF CERTAIN PREFERRED EMBODIMENTS

The present invention seeks to address and resolve the problem of early-stage funding shortfall by creating systems and methodologies that allow innovators to raise funds at the outset of commercialization when the need for such funds is greatest. The methodologies and systems are generally based upon the sale of tokens in the early stages of the commercialization process. The tokens then serve as the medium through which fees are paid to the innovator in exchange for leverage of the innovation. More particularly, after the innovation is developed and made available for leverage, the various entities seeking to leverage the innovation are required to purchase the tokens in order to pay their leverage fees. For clarity and convenience, the term “entity” as used herein is intended to encompass and may be used interchangeably with the terms “end user,” “buyer,” “public buyer,” or “purchasing entity.” More specifically, the term “entity” is intended to encompass one or more parties who are: (1) seeking to purchase tokens for investment, resale, or speculation; (2) seeking to purchase tokens to leverage some or all of an IP archetype; (3) seeking to purchase tokens to directly leverage some or all of an IP archetype; and/or (4) seeking to incorporate some or all of an IP archetype into an embodiment of an IP archetype.

Additionally, the term “blockchain” as used herein refers to any system incorporating technology that uses cryptography to link a plurality of transaction records such that any attempts to alter, or any alterations of, the previously linked transactions are readily exposed. Further, by way of clarification, the term “leverage” as used herein is intended to encompass all forms of usage of, access to, purchase of, or license of the innovation whether in the form of an archetype of the innovation or an embodiment of an archetype of the innovation.

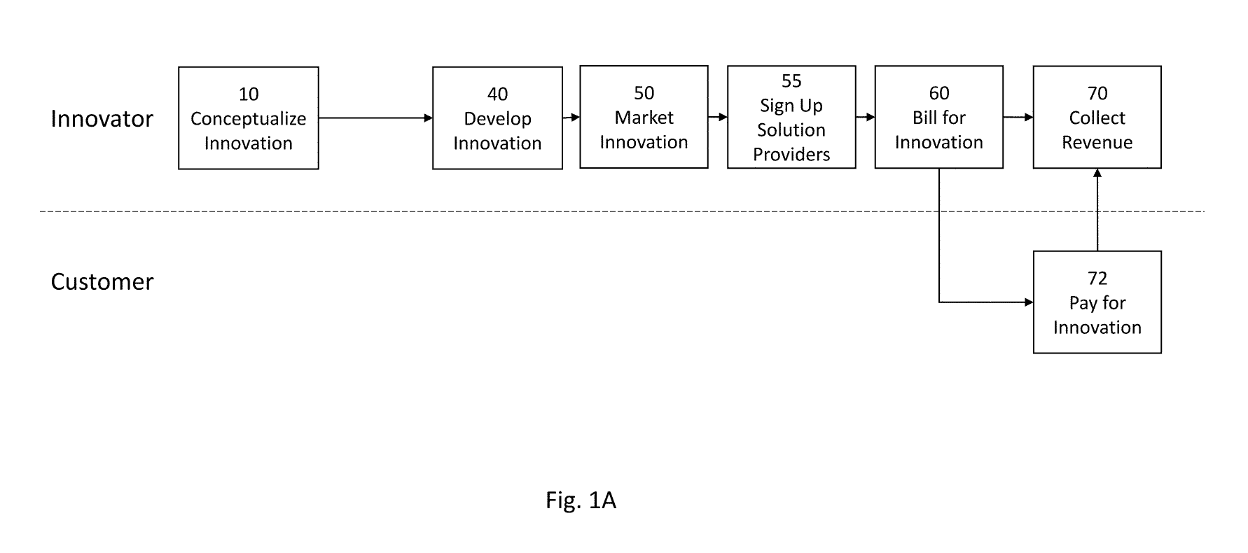

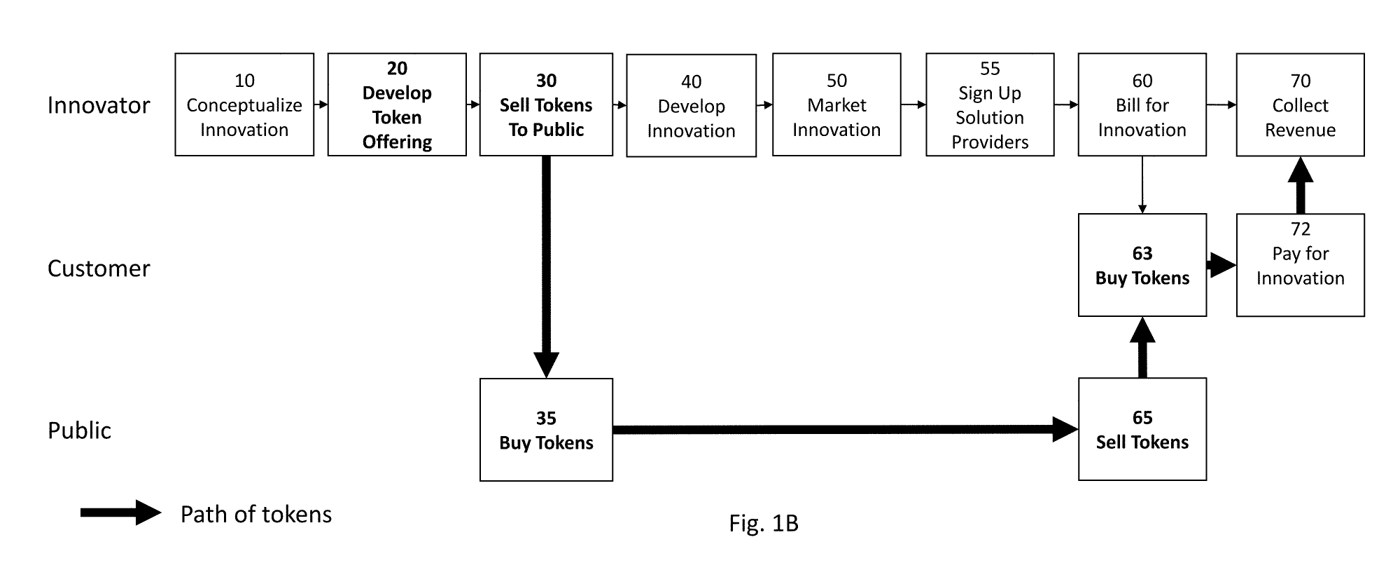

Innovative systems and methods designed to address innovator funding shortfalls are disclosed and described through the following several preferred embodiments and example applications. A typical current innovation development cycle is illustrated in FIG. 1A. The innovator first conceptualizes and documents the innovation 10. The conceptualize step may also include obtaining IP protection such as patents, which includes the drafting of applications, filing fees, and litigation fees, not to mention legal fees that may arise in trying to enforce the patent against infringers or defend patents against Inter Partes Reviews (IPRs) in which others seek to have a patent grant overturned.

The innovator then builds out the concept into a demonstrable product 40. This demonstration step may include the development of multiple proofs of concept, simulations, and prototypes to achieve a Minimum Viable Product that is sufficient to entice and pique the interest of customers.

The innovator must then market his demonstrable product to prospects 50 to discover customers willing to leverage his innovation 55. Only after this marketing effort (which may also include modifying his demonstrable product), is he able to bill for his innovation 60.

Finally, at 70, he begins collecting revenue for the leveraging of his innovation. This may be in the form of providing access to or licensing of the IP behind the product, a sale of the design, or sale of the product. Ideally, at some point in this final phase of the innovation development cycle, the innovator's cumulative cash flow will pass the breakeven point and he will begin earning profit for his innovative efforts. This final stage can continue for years as long as there is a market for the innovation. In addition, this stage may include extensions to, or improvements to, the IP that increase the marketability or value of the innovation. This step may also include the issuance of new tokens that may be specifically related to innovation extensions or improvements.

At any time in this flow, the innovator may expend additional energy and time into trying to market his innovation to investors (such as angel investor or venture capitalists to obtain working capital to bring the product to market. This typically requires the innovator to offer the investor(s) a share of his equity in the innovation, which may severely limit the ability for the innovator to directly profit from his or her innovation.

FIG. 1B shows a similar innovation development process, but now supplemented by a basic embodiment of the present invention. After conceptualizing the innovation, the innovator works to craft a token offering package 20. This may be as simple as writing a white paper describing his innovation and the needs that it fills, creating a token using available software, and listing his offering on any of a number of token offering websites. It may also include more sophisticated development of an offering prospectus, hiring a marketing or public-relations firm to promote his offering, and using other third-party services to optimize his offering. A key element of the offering is the disclosure that eventual leverage of the innovation must be paid for using the tokens.

The innovator then sells tokens to a plurality of crowdsourced investors who believe in the value of the innovation 30. In turn, investors buy tokens 35. Once purchased and issued, public investors in the tokens may buy and sell the tokens. The price of the tokens may fluctuate based on an investor's perceptions of the likelihood that a market will eventually arise for the tokens.

After billing a customer for the leveraging of all or part of his innovation 60, the customer must then obtain tokens to pay for what he is leveraging. He purchases tokens 63 from the public investors (or the token issuer) willing to sell them (e.g., for their current market value) 65. The customer may also use tokens previously purchased and “banked” in a storage wallet, and possibly purchased as a hedge against their increase in value.

The customer then pays for his leveraging of the innovation 72. In turn, the innovator collects this revenue 70 in the form of tokens. He may retain these tokens as a store of value with the expectation that they may appreciate in value as his leveraging revenue increases or he may sell them back to the open market to use the cash for expanding his business or as a reward for his innovative efforts.

Leveraging fees themselves may be established in terms of another benchmark currency (a fiat currency or a cryptocurrency). In this way, the number of tokens needed to pay a leverage fee will vary based on the value of the token vis a vis the currency used to price the leverage fee. This prevents a leverage fee based on tokens from becoming prohibitively expensive if the value of the tokens rises significantly. This would stifle the propagation of the innovation. Similarly, it protects the innovator from receiving limited value for his innovation if the value of the tokens declined markedly. Of course, the process could be replicated as new or modified innovations are conceived to fund their commercialization, as well.

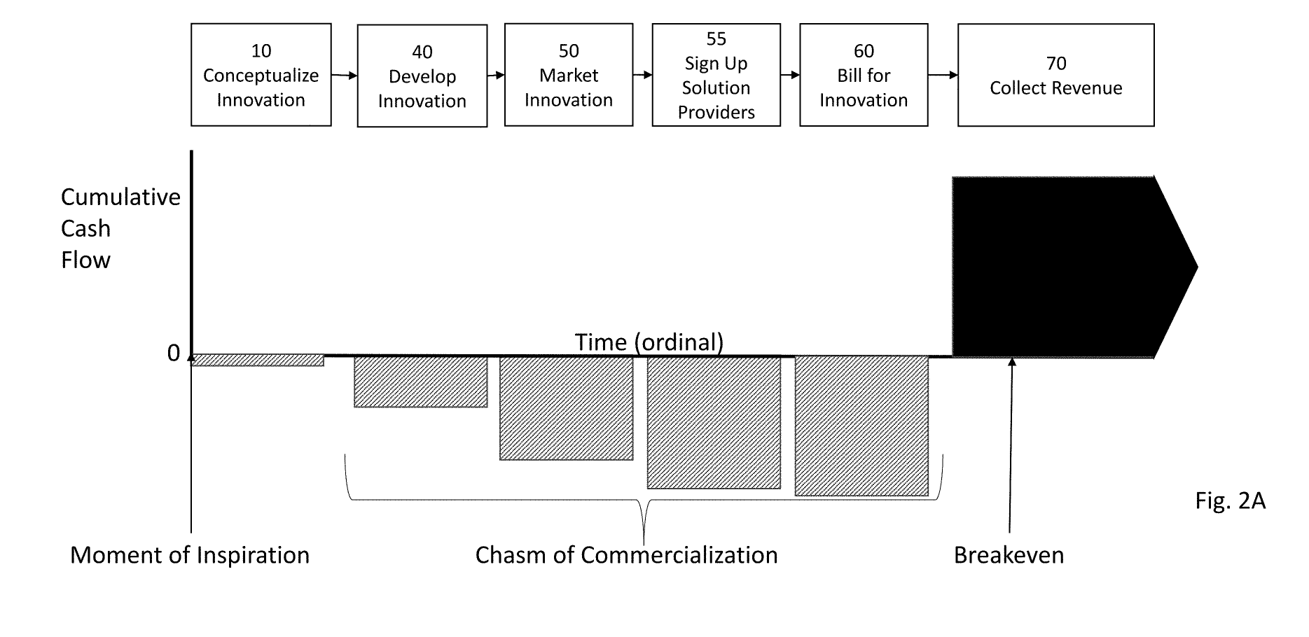

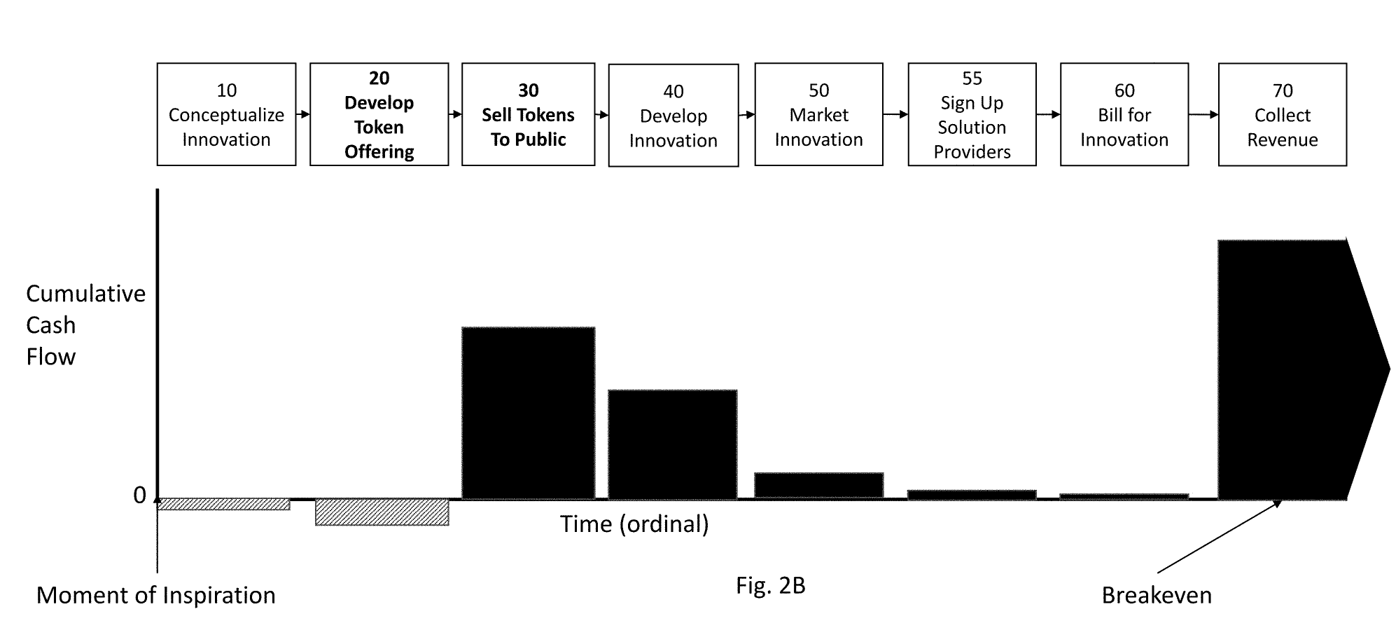

FIG. 2A shows the cumulative cash flow of the standard innovation development cycle, illustrated more fully in FIG. 1A, without the sale of equity. Observe that the cumulative cash flow is negative from the “Moment of Inspiration” until the point of “Breakeven.” In particular, the innovator's cumulative cash flow turns markedly negative through the “Chasm of Commercialization.” Many innovations stall as innovators attempt to traverse the Chasm of Commercialization. Even those Innovators who eventually obtain some form of equity funding often experience deep indebtedness just from the time and effort needed to interest investors and close an investment round.

The cash-flow “Chasm of Commercialization” can be obviated by creating a token offering early in the innovation development cycle as illustrated in FIG. 2B. As can be seen, the influx of cash from token sales can be used to fund the Develop Innovation 40 and Market Innovation 50 efforts which typically are the two highest cost items in the cycle. Once the token sale is successfully conducted, the innovator should have sufficient cash to invest in the Product Development 40 and Market Development 50 efforts to remain cash flow positive through the remainder of the innovation development cycle.

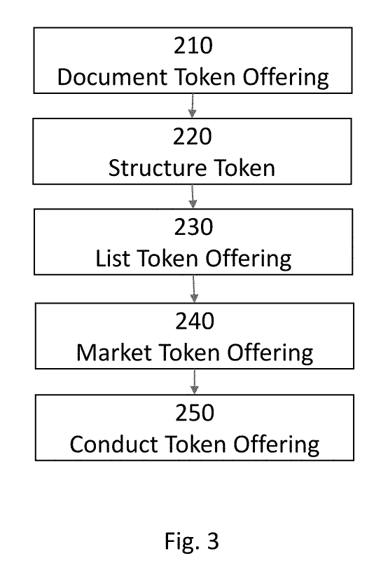

FIG. 3 expands the develop token offering process 20. The initial step is to define and document the terms of the token offering 210. This step may include a description of the IP and its potential value in the market, the innovator's business model and how he intends to generate revenue with the innovation, the competition and its impact on the success of the innovation, the features of the token to be sold in the offering to substantiate its value and ongoing marketability to prospective investors, the risks inherent in purchasing the tokens, the timing of the offering, and any other features likely to be of interest to potential token buyers. These other features include what happens to their money if the offer is not fully subscribed and/or if the initial offering is oversubscribed. Typically, this documentation is provided on a web site created for the company that will own the IP, with explicit pages listing the offering documentation.

The actual tokens then need to be created and structured 220. Token structure includes the name of the token, the “ticker” symbol it will be traded under, the number of tokens to be issued, the increments into which the token can be subdivided, and any special features of the token. At this writing, there is at least one standard (ERC-20) that allows tokens to be compatible with Ethereum-based wallets that may be used to allow to facilitate the buying and selling of the token on the Ethereum blockchain. The firm Bancor (www.bancor.network) has created what it hopes to become a standard for smart tokens that can be exchanged for other cryptocurrency tokens and fiat currencies increasing the liquidity of the token.

Various listing services are available for the listing of token offerings 230. These listing sites enable prospective token entities to access the token offering documentation and token structure to evaluate the investment opportunity. These sites also enable prospective purchasing entities to learn where to go to purchase the tokens during their initial offering.

Once the offering is defined and listed, innovators will want to market their offering 240 in order to ensure that they generate sufficient interest in their offering that it will be fully subscribed. This can be a costly step. But for innovators with low visibility, this effort is critical to ensure that they can raise the funding necessary to bring their innovation to market. Finally, the offering is conducted 250 by following the procedures outlined in the documented terms of the offering 210.

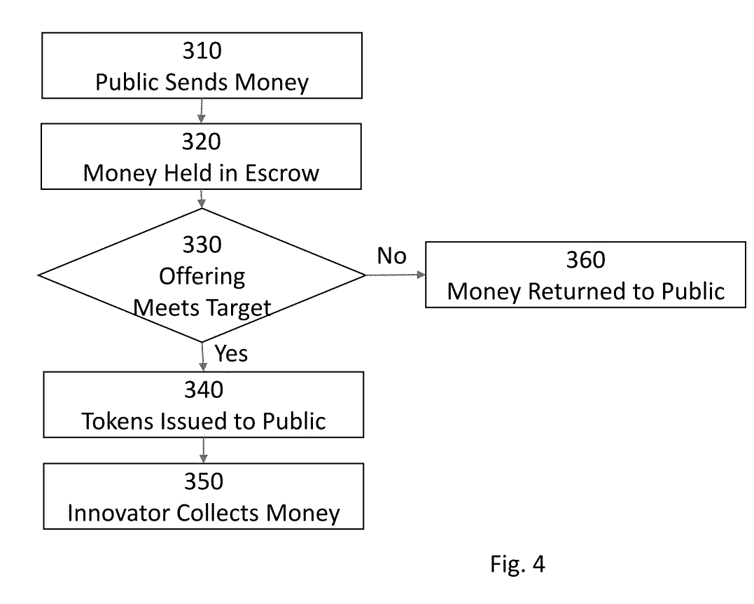

FIG. 4 expands upon and details the development of the token offering process 30. The public transfers money (such as fiat currency or cryptocurrencies) to an address established for the offering 310. The money is received at this address which acts as an escrow account 320. A decision point 330 determines if sufficient funds have been submitted by the public to go through with the offering. If the offering is sufficiently subscribed, tokens are issue to the public 340 and the proceeds of the offering are delivered to the innovator 350. If the offering is undersubscribed, the funds submitted by the public are returned to the public and the offering is concluded. The terms of both the escrow account and the determination of offering success are typically documented in the offering 210.

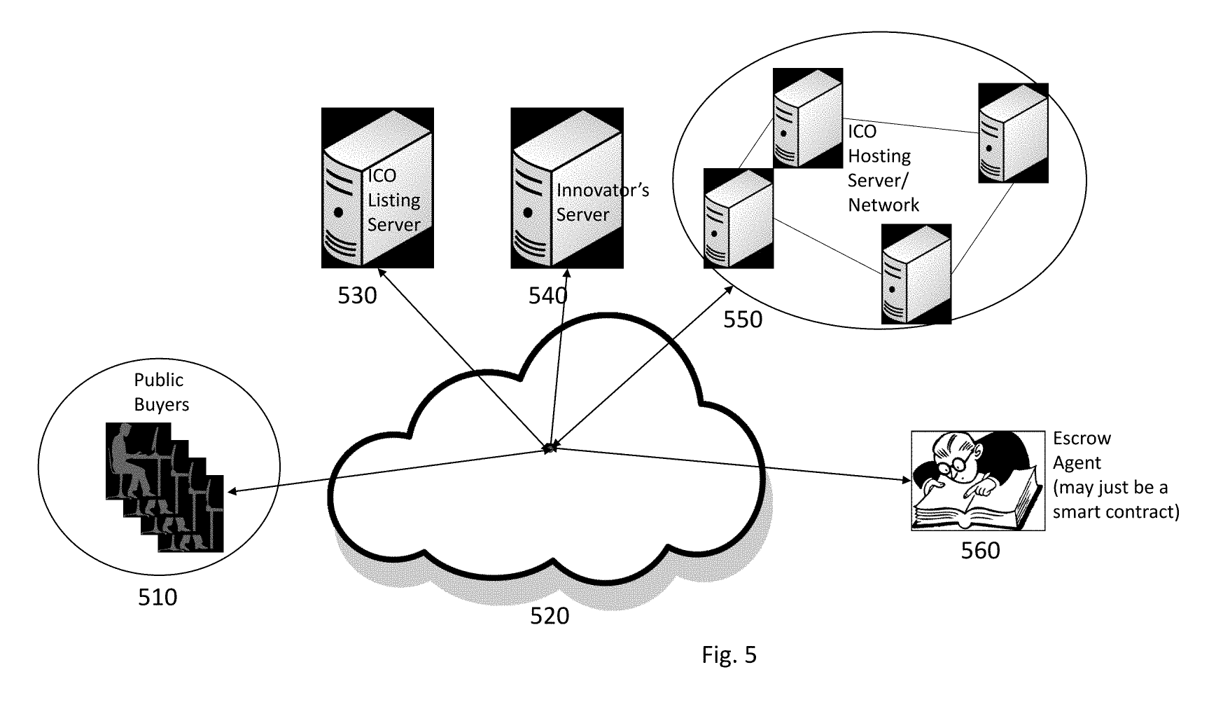

FIG. 5 displays the system components of this first tier computing platform. The public 510 first enrolls in the offering (520-530). Public buyers may be investors who anticipate a rising value for the token, entities seeking to leverage the invention such as end users of the innovation, solution providers intending to incorporate at least part of the innovation into a new solution, or solution-provider users expecting to use the new solution. Purchasing entities may also include others who may be purchasing the tokens for investment or other purposes unrelated to leveraging the innovation. To do this, prospects may use a telecommunications connection 520 to connect to an ICO listing server 530. The ICO listing server may list multiple ICOs and includes information (e.g., links) to direct the public to the details of each particular ICO. These details potentially include a white paper and web site for each innovator holding an ICO. They can also include a prospectus outlining the offer. These may be stored on an innovator-tier server 540, which may be the same physical server as the ICO listing server 530. The ICO listing server also includes information (e.g., links) to direct the public buyer to the ICO hosting server/network hosting the ICO 550.

The innovator tier is managed by the innovator-tier server 540 which may undertake one or more of the following operative steps or functions:
1. Registering entities seeking to leverage at least a portion of the innovator's IP;
2. Enrolling entities seeking to leverage at least a portion of the innovator's IP;
3. Vetting entities seeking to leverage at least a portion of the innovator's IP;
4. Orchestrating the enrollment and vetting of entities seeking to obtain the innovator's tokens;
5. Uploading tailored code to the ICO hosting server/network 550;
6. Generating the tokens used in the token offering;
7. Hosting a digital wallet to collect funds received through the token offering;
8. Collecting tokens received from entities leveraging the innovator's IP;
9. Maintaining an accounting of tokens issued, tokens received, and funds received;
10. Providing reports to the innovator (especially when the innovator-tier platform is not owned by the innovator); and/or
11. Providing reports to the platform owner.

If a member of the public elects to purchase tokens, he conducts a transaction with the ICO hosting server/network sending a specified value of fiat currency, cryptocurrency, or tokens to the escrow agent for the offering 560. If the offering is successful, the escrow agent issues tokens to the public buyers 510 through the ICO hosting server or blockchain network 550. He also forwards the proceeds of the offering to the Innovator 540 by conducting a transaction on the blockchain in the ICO hosting server/network.

If the offering is not successful, the escrow agent 560 conducts blockchain transactions with the ICO hosting server returning funds to the public buyers 510.

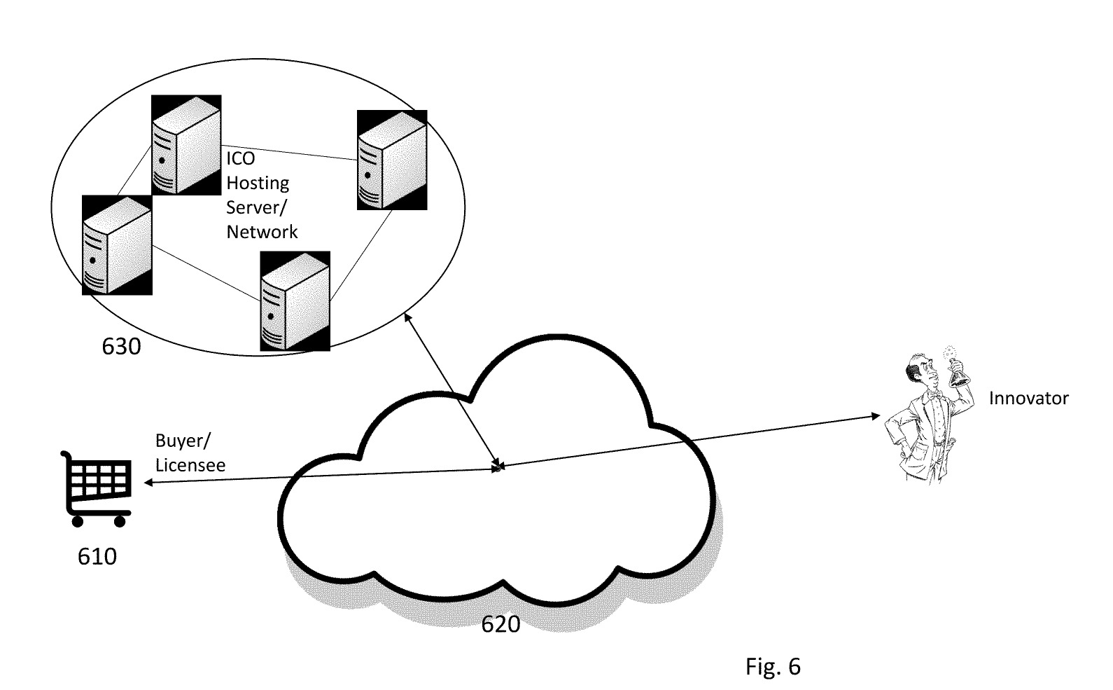

Once issued, the tokens are then used to pay leverage fees in FIG. 6. An entity (which, in this case, may be an end user or a solution provider who incorporates the innovation into another solution) leveraging the innovation 610 uses a telecommunications connection to access a blockchain network 630 in order to purchase the tokens it needs to pay its leverage fees. It then sends these tokens to the innovator 640. It will be appreciated that this transfer may be performed by conducting a second transaction on the blockchain network sending the cryptotokens to the innovator by transferring them from the account address of the current owner to the address of the innovator's account.

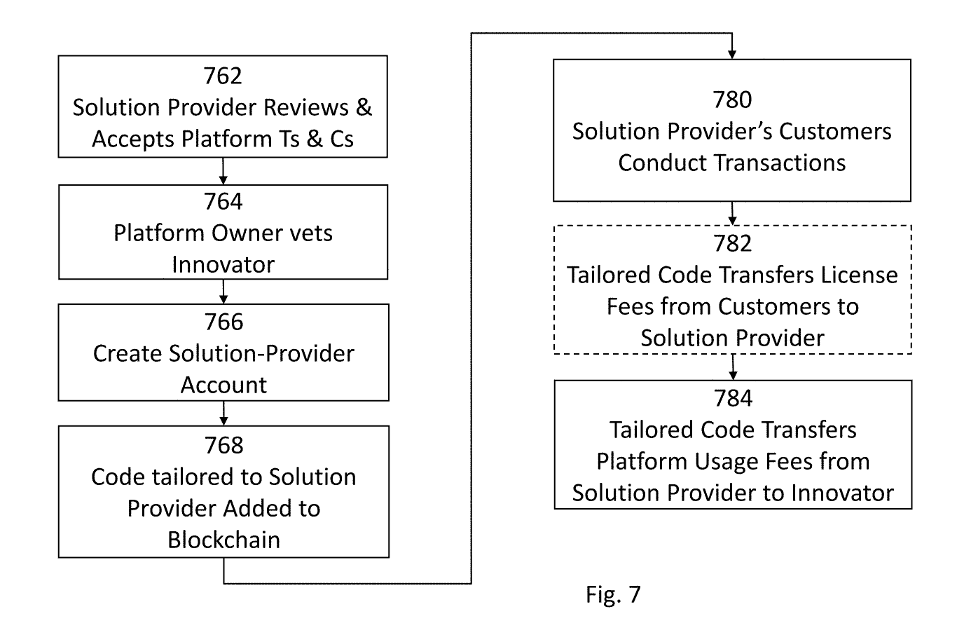

In a different preferred embodiment of the present invention, an innovator may construct a second tier platform to provide a standard method for multiple solution providers to leverage the innovative IP. This second tier computing platform accomplishes automated billing and collection of revenues (steps 60 and 70 in FIG. 1B) from the first tier solutions offered by each solution provider. This approach, depicted in FIG. 7, allows solution providers a way to quickly add the innovation to an offering, without delays as often occur during negotiations of terms, including pricing. This embodiment begins with the enrollment of a solution provider (762-766). The solution provider first reviews the terms and conditions associated with the IP 762 to determine if he wants to use it. Terms include pricing, limits on repurposing the IP and other factors that the innovator dictates. The innovator, may be the platform owner. Alternatively, the innovator may outsource the platform function to a third-party platform owner.

If the solution provider accepts the terms and conditions, the platform owner then vets the solution provider to ensure that the solution provider is legitimate and will not cause harm to the platform's brand 764. He may do this using a variety of means that may include checking a reputation system, a credit bureau report, or other similar sources. Some of these methods may be fully automated.

Once the vetting has been passed, the platform creates an account for the solution provider 766. The account can include login information and payment information to facilitate the payment of IP leverage fees.

Following enrollment, implementation begins (768-784). The platform owner then adds code tailored for the new solution provider to the blockchain 768. Different code may be required to support the variety of blockchain-based supply-chain solutions hosted on a variety of different blockchains. The code may also include provision to pay the solution provider as transactions occur using his solution. This enables the solution provider and his solution provider users to begin using his blockchain solution 770 on the platform that best meets their needs. In this illustration, the code automatically transfers applicable fees to the solution provider 772 for use of his solution. The decision to include this function in the tailored code will be at the discretion of the solution provider.

The tailored code then processes payment of leverage fees 774 to the innovator/platform owner. Leverage fees will be processed by this code (sometimes called a “smart contract”) as established by the terms of the leverage agreement or license. It may deduct tokens from the solution provider's wallet or initiate a sub-process to purchase tokens on the open market that will be transferred to the platform owner.

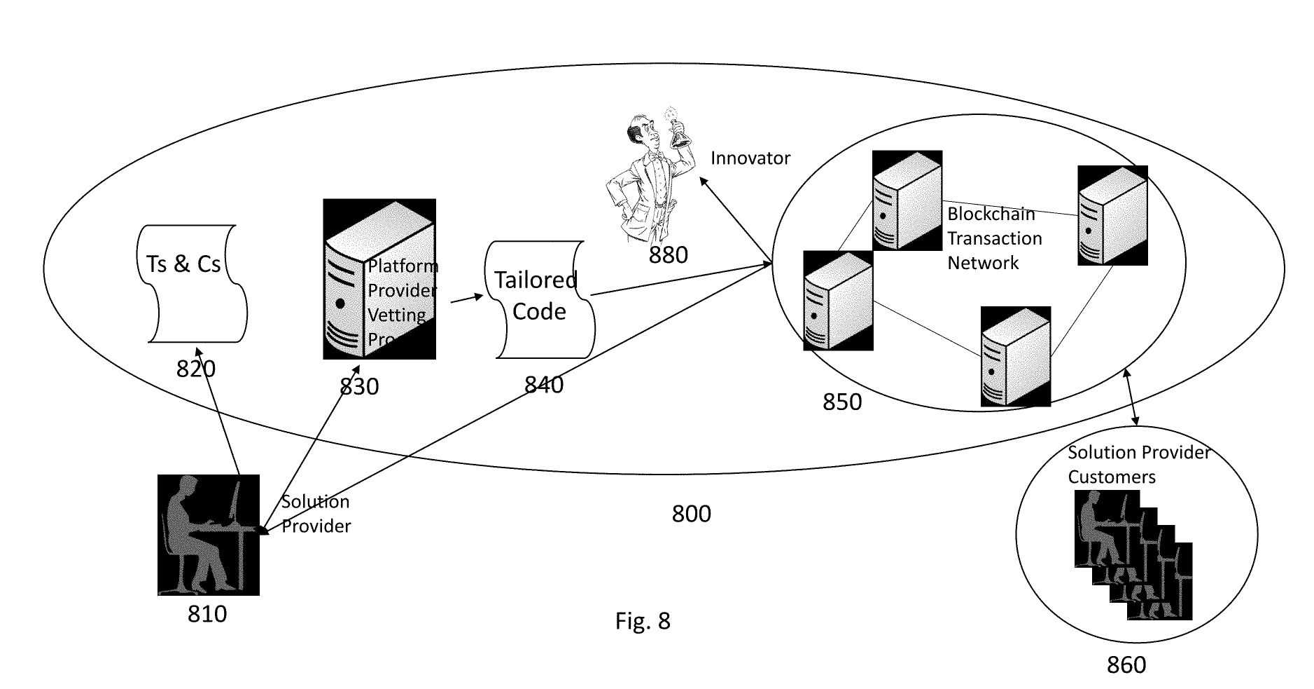

The various elements of this platform system for solution providers are shown in FIG. 8. In this figure a solution-provider tier is layered below the innovator tier to allow a solution provider to leverage an innovation by incorporating it into his own solution and to use this additional tier to service his own solution-provider users. A solution provider 810 interested in using the innovator's IP, conducts his own enrollment process for his clients. This may begin when a prospective client reviews the standardized terms and conditions of the IP-leverage agreement 820. If these are acceptable, a solution-provider-tier server 830 may conduct a vetting process. The vetting process verifies the solution provider's integrity and assesses any likelihood that the solution provider's solution may damage the platform owner's brand. While it is preferable that some elements of this process are undertaken automatically through the innovator-tier computing platform, the process may also be conducted manually.

The solution-provider tier is managed by the solution-provider-tier server 830 which may provide one or more of the operative steps or functions:
1. Registering entities seeking to leverage the solution-provider's embodiment of the IP;
2. Enrolling entities seeking to leverage the solution-provider's embodiment of the IP;
3. Vetting entities seeking to leverage the solution-provider's embodiment of the IP;
4. Orchestrating the enrollment and vetting of entities seeking to leverage the innovator's tokens;
5. Tailoring of code 840 to be added to the hosting server/network 850;
6. Hosting a digital wallet to dispense innovator-tokens to the innovator;
7. Maintaining an accounting of the leveraging of the innovator's IP;
8. Maintaining an accounting of the payments made to the innovator;
9. Providing reports to the solution provider;
10. Providing reports to the innovator; and/or
11. Providing reports to the platform owner.

The tailoring of code 840 addresses the particular platform 850, which can be a blockchain, that the solution provider is using and facilitates transfer of value to the innovator/platform provider. The platform may use a technology other than a blockchain platform that offers the ability to create trusted records of transactions and payments and can execute the tailored code. The code is then added to the solution provider's platform on which the solution provider hosts his solution.

If the solution provider conducts his own ICO, the solution-provider-tier computing server may also provide one or more of the following operative steps or functions:
1. Generating the solution-provider tokens used in the token offering;
2. Hosting a digital wallet to collect funds received as a result of the token offering;
3. Collecting tokens received from entities leveraging the solution-provider's solution;
4. Maintaining an accounting of tokens issued, tokens received, and funds received; and/or
5. Providing reports to appropriate users and parties.

Once the solution provider's system is enabled with the tailored code, his solution-provider users 860 can begin using the system. Their usage triggers the tailored code which transfers tokens to the innovator/platform owner 880. In the case where the innovator and platform provider are separate entities, the tailored code may transfer tokens to both parties according to agreed-upon terms embodied in the tailored code. Also, as noted above, this transfer may take tokens from the solution provider's account and/or purchase tokens on the open market and transfer them to the innovator/platform provider. The tailored code may also be the mechanism to transfer payments to the solution provider.

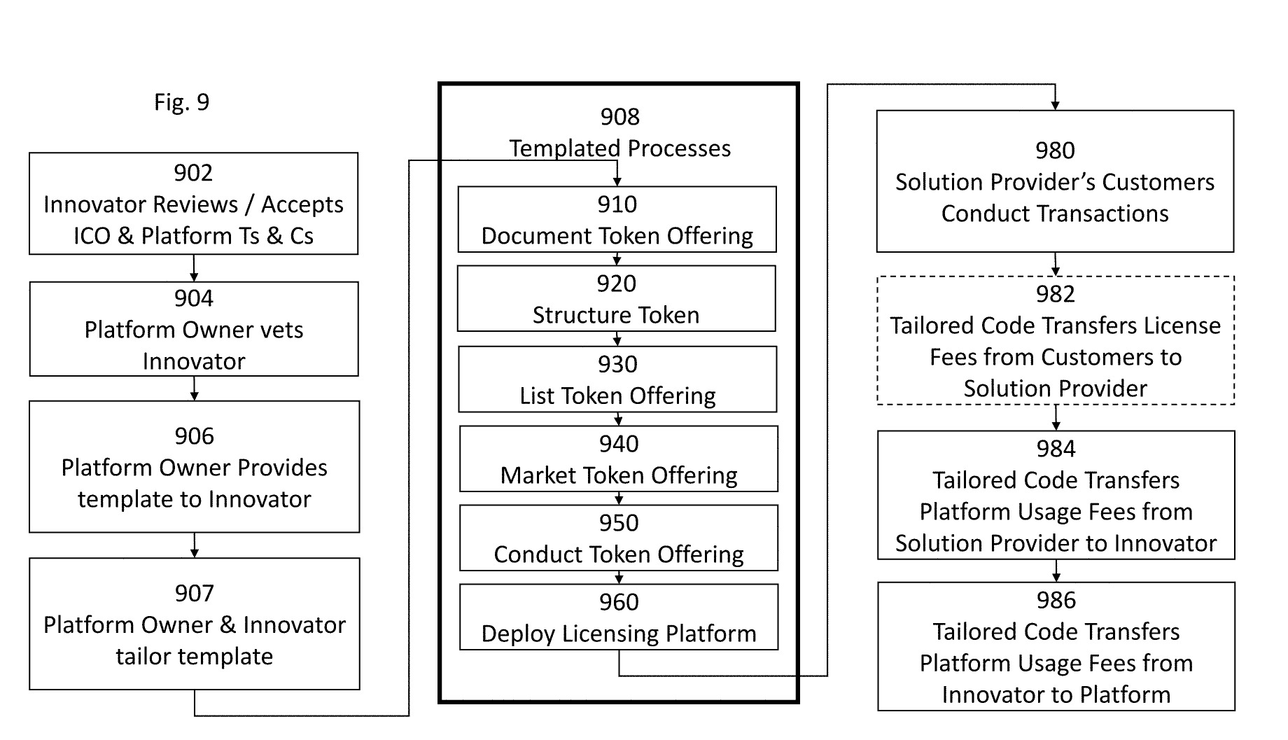

In another embodiment of the invention, illustrated in FIG. 9, a master platform for innovators is created. As shown in FIG. 9, the platform supports multiple innovators each with their own sets of end users and solution-providers seeking to leverage their technology, along with solution-provider users seeking to leverage the respective solution-providers' solutions. In this embodiment, the third tier computing platform creates the second tier computing platform for each innovator similar to that depicted in FIGS. 7 and 8. More particularly, the third tier platform facilitates and may standardize the registration of multiple innovations, each of which receives its own stream of leverage revenues from transactions that use the innovation. The platform may create standard terms that will apply to all those seeking to use the platform, precluding the need to negotiate hundreds of sets of 1-to-1 terms. This master platform may also offer a standardized set of procedures to inexpensively conduct the token generating event to fund the innovator.

The third tier computing platform process begins with enrollment of innovators who compose its clientele (902-904). At least one innovator who has proprietary IP that he desires to offer for leverage can review the terms and conditions of both the platform and the ICO that it may facilitate for the innovator 902. Once the innovator agrees to the terms and conditions, the platform owner can initiate a process to vet the risks of working with the innovator 904. This may include credit-worthiness, reputation, and/or other factors that the platform owner considers of importance. This process may be automated.

Once the platform owner is comfortable working with each innovator, he transmits a template to the innovator 906. The template establishes the structure of the resulting platform to be used to enlist solution providers interested in leveraging the innovator's technology. It may also establish the structure of an ICO.

The platform owner and innovator tailor the template as necessary 907. The templated processes 908 are then executed. The platform may generate the token offering documentation 910. It may also create the token structure as documented in the tailored template 920. It may facilitate the listing of the ICO offering with listing services specified in the template 930. It may follow tailored template guidelines to automate some of the marketing of the offering 940. This may include sending out news releases to appropriate media, creating a web site to promote the innovation, and distributing the offering document. The innovator may also pursue additional marketing efforts.

Once the above events have been completed the token offering is conducted 950. This, too, may be automated in whole or in part by the platform. The platform may also trigger the establishment of a new child platform 960 to be used by each innovator in the same way that the platform in FIG. 8 operates. This may include the establishment of a new blockchain or similar data structure as determined by each innovator.

At this point, the new child platform operates, conducting steps 980, 982, and 984 in the same way as depicted in FIG. 7 steps 780, 782, and 784. The difference is that there may be multiple innovators each with his own child platform. Each operates independently and funds are transferred from solution provider clients to the appropriate solution provider 982, and innovator 984. The additional step 986 causes the tailored code to transfer platform leverage fees to the platform owner. In this case the platform owner may be distinct from the innovator.

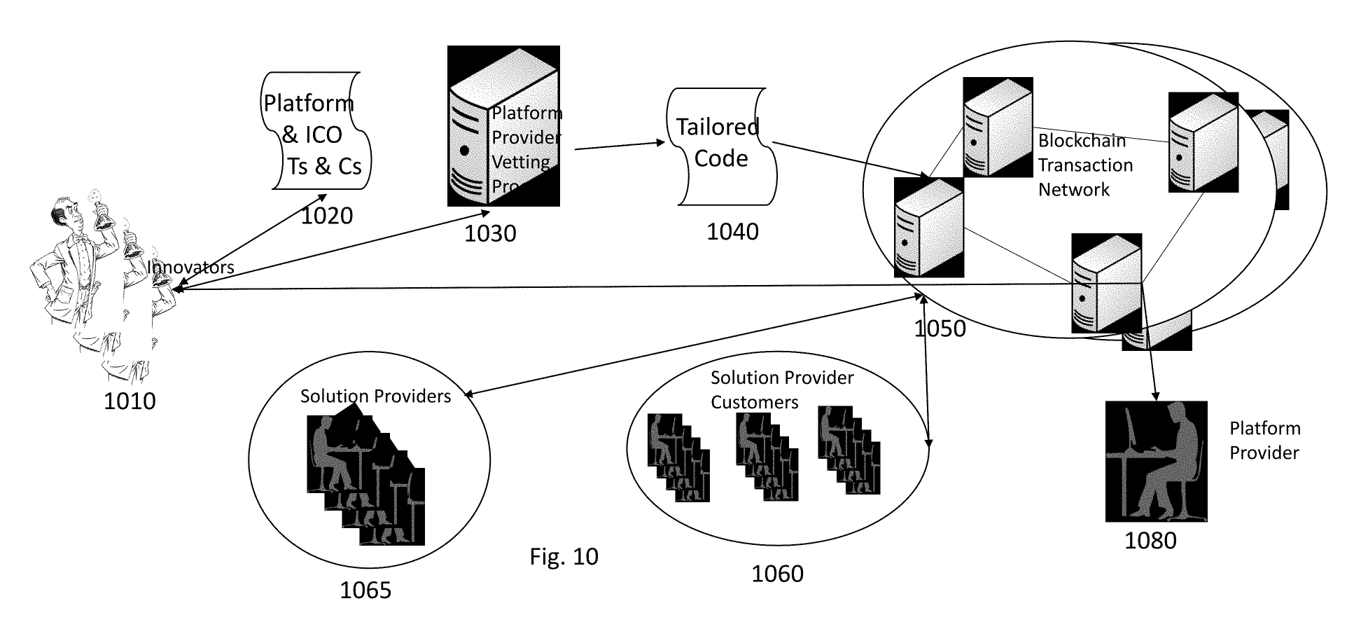

The various elements of this platform system for innovators are shown in FIG. 10. Each innovator 1010 interested in using the platform to offer leverage of his IP, reviews the standardized terms and conditions of the platform usage agreement 1020, including terms for an ICO, if applicable. If these are acceptable, the platform owner may then vet each innovator 1030. The vetting process verifies the innovator's integrity and assesses any likelihood that the innovators IP or list likely solution provider clients' solutions may damage the platform owner's brand. The platform owner and innovator may also elect to vet solution providers.

This vetting process may begin when a prospective innovator 1010 reviews the standardized terms and conditions of the platform-usage agreement 1020. If these are acceptable, a master-tier server 1030 may conduct a vetting process. The vetting process verifies the solution provider's integrity and assesses any likelihood that the solution provider's solution may damage the platform owner's brand. The process may also be conducted manually.

The master tier is managed by the master-tier server 1030 which may provide one or more of the following operative steps or functions:
1. Registering entities seeking to use the master-tier platform;
2. Enrolling entities seeking to use the master-tier platform;
3. Vetting entities seeking to use the master-tier platform;
4. Orchestrating the enrollment and vetting of entities seeking to use the master-tier platform;
5. Tailoring of code 1040 to be added to the hosting server/network 1050;
6. Maintaining an accounting of the use of the master-tier platform;
7. Maintaining an accounting of the payments received for the use the master-tier platform;
8. Providing reports to innovator clients; and/or
9. Providing reports to the master-tier platform owner.

The tailored code 1040 may include a new data structure such as a blockchain. The innovator may also create tailored code as in 840. The platform provider then enables a complete system for each innovator 1050. Such systems may leverage existing blockchain infrastructure, such as Ethereum or various Hyperledger offerings. In some embodiments, the same infrastructure may be used to host multiple innovator platforms if they can be constructed to conform to a common infrastructure.

Once the system is operational, solution providers 1065 can join the platform following the process in FIG. 7. They can then open the platform to use by their solution-provider users 1060. The tailored code in the blockchain conducts transactions to pay the innovator 1010 and platform owner 1080. It may also conduct transactions to pay the solution provider.

Once vetted, code is tailored 840 for the solution provider's design. This tailoring addresses the particular blockchain platform 850 that the solution provider is using and facilitates transfer of value to the platform provider. The code is then added to the blockchain network on which the solution provider mounts his solution.

Once the solution provider's system is enabled with the tailored code, his solution-provider users 860 can begin using the system. Their usage triggers the tailored code which transfers tokens to the innovator/platform owner 880. In the case where the innovator and platform provider are separate entities, the tailored code may transfer tokens to both parties according to agreed-upon terms embodied in the tailored code. Also, as noted above, this transfer may take tokens from the solution provider's account and/or purchase tokens on the open market and transfer them to the innovator/platform provider. The tailored code may also be the mechanism to transfer payments to the solution provider.

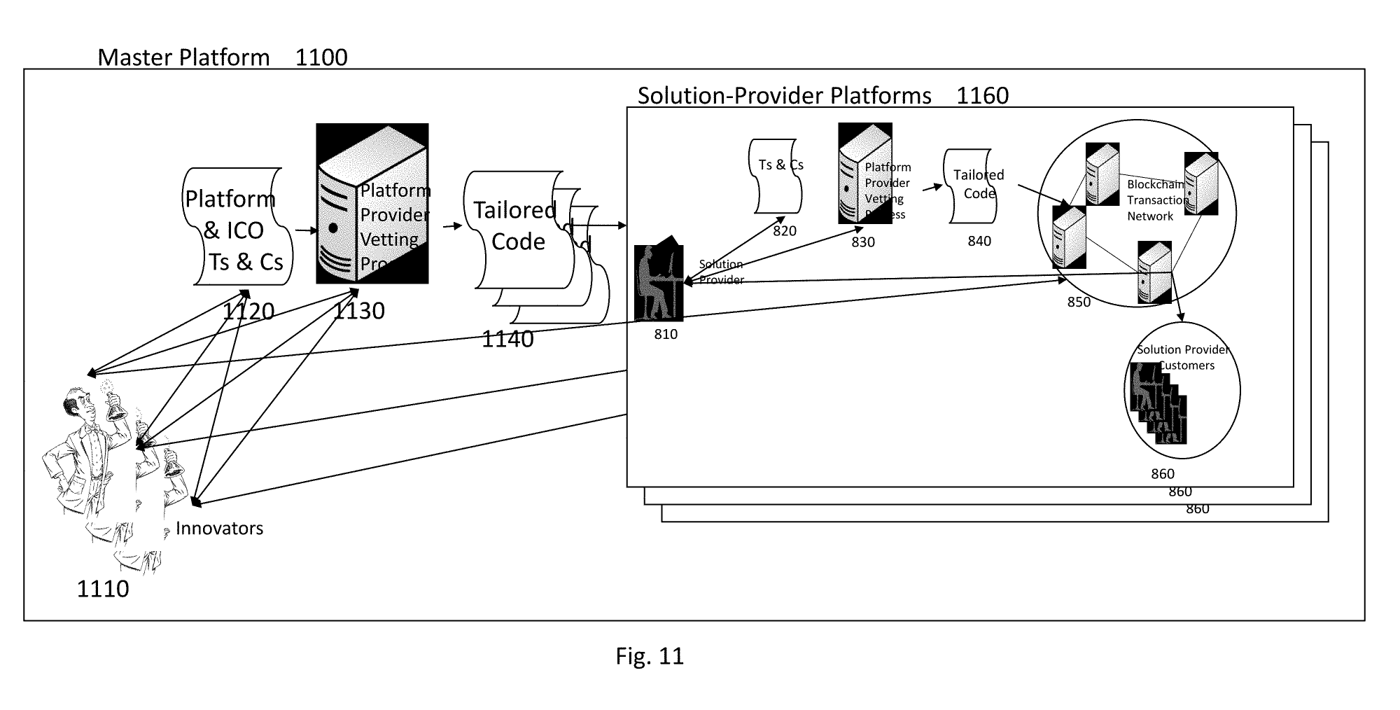

The potential tiering of platforms is illustrated in FIG. 11. As shown, the master platform 1100 is designed to support multiple innovators 1110. The master platform 1100 provides a Terms-and-Conditions server 1120, Vetting Server 1130, and tailored code that is unique to each innovator 1140 and that is instantiated on the blockchain transaction network 1150, and further becomes part of the innovator tier platform 1160. (Though not shown in the illustration, this platform includes the innovators 1110). Public buyers interested in each innovator's tokens 1170 access the network to purchase tokens for use or resale. For those buyers who are also solution providers, solution-provider platforms can then be established 1170 that are multiple instances of FIG. 8.

While preferred embodiments of the inventive system, processes, and methodologies have been described and disclosed, in particular with reference to certain figures and exemplary embodiments for an innovative means for obtaining financing early in the innovation development cycle to assist in the development and marketing of an innovation, such exemplary representations are not to be construed as limiting the scope of application of the inventive methodologies or systems.

While the application of the methods and systems described herein focused on technology innovations, these same methods and systems could be readily applied to a wide variety of non-technology related works. By way of example, the inventive system has equal application to the development of creative works such as music, theatre, and the independent or small-scale film industry.

It will be recognized by those skilled in the art that other modifications, substitutions, and/or other applications are possible and such modifications, substitutions, and applications are within the true scope and spirit of the present invention. It is likewise understood that the attached claims are intended to cover all such modifications, substitutions, and/or applications.

1. A method for monetizing intellectual property (IP) archetypes created by at least one innovator, wherein said method for monetizing IP entails creation, distribution, collection, and accounting of cryptographic tokens, said method using a computer infrastructure incorporating a transaction record comprising a plurality of linked transactions that utilize cryptographic techniques that expose alterations of any of said plurality of linked transactions, (“Tamper-Resistant Transaction Record”), said method for monetizing IP being executed on a non-transitory machine-readable medium operating on an innovator-tier computing platform, said method comprising the steps of:
a) receiving a set of instructions from said at least one innovator to structure and operate an innovator-tier server, said set of instructions comprising:
i. a first set of procedures for registering and enrolling each of at least one entity (“Leveraging Entity”) seeking to buy, sell, modify, distribute, license, or use (“Leverage”) at least one embodiment of said IP archetypes; and
ii. a second set of procedures for confirming and documenting an agreement by each of said at least one Leveraging Entity to a set of terms and conditions for use of said at least one embodiment of said IP archetype;
iii. a third set of procedures for accounting for any Leveraging of said at least one embodiment of said IP archetypes by said at least one Leveraging Entity;
communicating said set of
b) instructions to each of said at least one Leveraging Entity;
c) receiving input from each of said at least one Leveraging Entity in response to said set of instructions;
d) creating unique token management code based upon input from said at least one innovator incorporating said set of terms and conditions for use of at least one embodiment of said IP archetype, said unique token management code to be executed on said innovator-tier platform to leverage and account for transactions of a plurality of cryptographic tokens, said unique token management code comprising at least one of the following steps,
i. defining a level of access allowable by each of said at least one Leveraging Entity to said innovator-tier platform;
ii. defining a scope of use of said at least one embodiment of said IP archetypes by each of said at least one Leveraging Entity;
iii. defining a duration of use of said innovator-tier platform by each of said at least one Leveraging Entity;
iv. defining an algorithm for calculating a fee structure for said Leveraging of said at least one embodiment of said IP archetypes by each of said at least one Leveraging Entity;
e) executing said unique token management code, wherein said executing includes at least one of the following steps:
i. distributing a first plurality of cryptographic tokens to at least one Leveraging Entity in exchange for a first consideration provided by said at least one Leveraging Entity, wherein said distributing includes at least one of the following steps:
a) receiving said first consideration from said at least one Leveraging Entity;
b) transmitting said first plurality of cryptographic tokens to an account of said at least one Leveraging Entity; and
c) creating a transaction to be recorded in said Tamper-Resistant Transaction Record including said first consideration and said first plurality of cryptographic tokens;
ii. collecting a second plurality of cryptographic tokens from each of said at least one Leveraging Entity in exchange for providing Leverage of said at least one embodiment of said IP archetypes, where said collecting includes at least one of the following steps;
a) receiving a signal from each of said at least one Leveraging Entity indicating interest in Leveraging said at least one embodiment of said IP archetype;
b) sending a signal to retrieve said second plurality of cryptographic tokens from the account of each of said at least one Leveraging Entity commensurate with said indication of interest in leveraging of said at least one embodiment of said IP archetype by said at least one Leveraging Entity;
c) receiving a signal from said at least one leveraging Entity transferring said second plurality of cryptograhic tokens as a second consideration for said indication of interest in Leveraging of said at least one embodiment of said IP archetype by said at least one Leveraging Entity; and
d) approving access by said at least one Leveraging Entity to said at least one embodiment of said IP archetype;
iii. accounting said distributing and collecting of said first and second plurality of cryptographic tokens to and from said at least one Leveraging Entity; and
iv. accounting for said Leveraging of said at least one embodiment of said IP archetypes,
wherein monetization of said at least one embodiment of said IP archetypes is realized through receipt of said first and second consideration in exchange for said Leverage of said at least one embodiment of said IP archetypes by said at least one Leveraging Entity, and through the distribution and receipt of said first and second plurality of cryptographic tokens.

2. The method for monetizing IP archetypes created by at least one innovator, wherein said method operates on an innovator-tier computing platform, as provided in claim 1, further comprising at least one solution-provider tier computing platform operating a non-transitory machine-readable medium comprising the step of providing the ability to Leverage at least one embodiment of said IP archetypes to at least one solution-provider users.

3. The method for monetizing IP archetypes, as provided in claim 2, wherein said at least one solution-provider tier computing platform further comprises:
a. a first set of procedures for registering and enrolling said at least one solution-provider users seeking to Leverage said at least one embodiment of said IP archetypes implemented by at least one solution provider;
b. a second set of procedures for confirming and documenting an agreement by said at least one of solution-provider users to terms and conditions provided by said solution-provider tier computing platform;
c. a third set of procedures for incorporating applicable terms and conditions into said at least one solution-provider tier computing platform prior to providing any of said at least one solution provider users access to Leverage of said at least one embodiment of said IP archetypes implemented by said at least one solution provider; and
d. a fourth set of procedures for managing said solution-provider tier computing platform.

4. The method for monetizing IP archetypes created by at least one innovator, as provided in claim 1, further comprising a master-tier computing platform operating a non-transitory machine-readable medium comprising the steps of:
a. a first set of procedures for registering and enrolling each of said at least one innovators seeking to offer said at least one embodiment of said IP archetypes to said at least one Leveraging Entity seeking to Leverage at least one embodiment of said at least one IP archetypes;
b. a second set of procedures for confirming and documenting an agreement by each of said at least one innovators to a set of terms and conditions provided by said master-tier computing platform;
c. a third set of procedures for accounting between said master-tier computing
d. a fourth set of procedures for accounting between said master-tier computing platform and said innovator-tier computing platform for said distributing and collecting of said first and second plurality of cryptographic tokens.

5. (canceled)

6. The method for monetizing IP archetypes created by at least one innovator, as provided in claim 3, wherein said fourth set of procedures for managing said solution-provider tier computing platform comprises at least one of; registering each of said at least one Leveraging Entity seeking to Leverage said at least one embodiment of said IP archetypes; enrolling each of said at least one Leveraging Entity seeking to Leverage said at least one embodiment of said IP archetypes; vetting each of said at least one Leveraging seeking to Leverage said at least one embodiment of said IP archetypes; and maintaining an accounting of payments received and issued in return for Leveraging said at least one embodiment of said IP archetypes.

7. The method for monetizing IP archetypes created by at least one innovator, as provided in claim 4, wherein said third set of procedures for managing said master-tier computing platform comprises at least one of: registering each of said at least one entity seeking to use said master-tier platform; enrolling each of said at least one entity seeking to use said master-tier platform; vetting each of said at least one entity seeking to use said master-tier platform; and maintaining an accounting of use of and payments received for use of said master-tier platform.

8. A system for monetizing intellectual property (IP) archetypes created by at least one innovator, wherein said system for monetizing entails distribution, collection, and accounting of cryptographic tokens, said system using a computer infrastructure incorporating a transaction record comprising a plurality of linked transactions that utilize cryptographic techniques that expose alterations of any of said plurality of linked transactions (“Tamper-Resistant Transaction Record”), said system comprising:
A. at least one innovator-tier computer server executing a first set of non-transitory machine-readable code that configures and operates a segment of at least one innovator-tier computing platform; wherein said at least one innovator-tier computer server undertakes at least one of the following actions:
a) receive a set of instructions from said at least one innovator to structure and operate an innovator-tier server, said set of instructions comprising:
i. a first set of procedures for registering and enrolling each of at least one entity (“Leveraging Entity”) seeking to buy, sell, modify, distribute, license, or use (“Leverage”) at least one embodiment of said IP archetypes; and
ii. a second set of procedures for confirming and documenting an agreement by each of said at least one Leveraging Entity to a set of terms and conditions for said Leveraging of said at least one embodiment of said IP archetype:
iii. a third set of procedures for accounting for any Leveraging of said at least one embodiment of said IP archetypes by said at least one Leveraging Entity;
b) communicate said set of instruction to each of said at least one Leveraging Entity;
c) receive input from each of said at least one Leveraging Entity in response to said set of instructions;
d. create unique token management code based upon input from said at least one innovator incorporating said set of terms and conditions for use of at least one embodiment of said IP archetypes, said unique token management code to be executed on said innovator-tier platform to Leverage and account for transactions of a plurality of cryptographic tokens, said unique token management code comprising at least one of the following steps:
i. defining a level of access allowable by each of said at least one Leveraging Entity to said innovator-tier platform;
ii. defining a scope of use of said at least one embodiment of said IP archetypes by each of said at least one Leveraging Entity;
iii. defining a duration of use of said innovator-tier platform by each of said at least one Leveraging Entity;
iv. defining an algorithm for calculating a fee structure for said Leveraging of said at least one embodiment of said IP archetypes by each of said at least one Leveraging Entity;
e) execute said unique token management code, wherein said executing includes at least one of the following steps:
i. distributing a first plurality of cryptographic tokens to at least one Leveraging Entity in exchange for a first consideration provided by said at least one Leveraging Entity, wherein said distributing includes at least one of the following steps;
a) receiving said first consideration front said at least one Leveraging Entity;
b) transmitting said first plurality of cryptographic tokens to an account of said at least one Leveraging Entity; and
c) creating a transaction to be recorded in said Tamper-Resistant Transaction Record including said first consideration and said first plurality of cryptographic tokens;
ii. collecting a second plurality of cryptographic tokens from each of said at least one Leveraging Entity in exchange for providing Leverage of said at least one embodiment of said IP archetype, where said collecting includes at least one of the following steps:
a) receiving a signal from each of said at least one Leveraging Entity indicating interest in Leveraging said at least one embodiment of said IP archetype;
b) sending a signal to retrieve said second plurality of cryptographic tokens from the account of each of said at least one Leveraging Entity commensurate with said indication of interest in Leveraging of said at least one embodiment of said IP archetype by said at least one Leveraging Entity;
c) receiving a signal from said at least one Leveraging Entity transferring said second plurality of cryptographic tokens as a second consideration for said indication of interest in Leveraging of said at least one embodiment of said IP archetype by said least one Leveraging Entity; and
d) approving access by said at least one Leveraging Entity to said at least one embodiment of said IP archetype;
f) account for said distributing and collecting of said first and second plurality of created cryptographic tokens to and from said at least one Leveraging Entity; and
g) account for said Leverage of said at least one embodiment of said IP archetypes.
B. at least one computing node executing a second set of non-transitory machine-readable code operating said Tamper-Resistant Transaction Record, wherein said at least one computing node records said distribution and collection of said first and second plurality of cryptographic tokens on said Tamper-Resistant Transaction Record;
C. at least one Leveraging Entity computing device, wherein said at least one Leveraging Entity computing device executes at least one of the following actions;
a) receive said set of instructions front said at least one innovator-tier computer server;
b) transmit input front said at least one Leveraging Entity in response to said set of instructions to use said innovator-tier computing platform;
c) send a signal to purchase cryptographic tokens;
d) receive a signal confirming said purchase of said first plurality of cryptographic tokens;
e) transfer of said second plurality of cryptographic tokens to innovator-tier platform as consideration for Leverage of said at least one embodiment of said IP archetypes; and
f) Leverage said at least one embodiment of said IP archetypes;
D. a communications network to which said at least one said innovator-tier server, said at least one computing node, and said at least one Leveraging entity computing device are communicatively connected.

9. The system for monetizing IP archetypes created by at least one innovator, as provided in claim 8, further comprising at least one solution-provider tier computing platform operating a non-transitory machine-readable medium comprising the step of providing the ability to Leverage at least one embodiment of said IP archetypes to at least one solution-provider users.

10. The system for monetizing IP archetypes, as provided in claim 9, wherein said at least one solution-provider tier computing platform comprises at least one computer server executing non-transitory machine-readable code undertaking the steps of:
a. a first set of procedures for registering and enrolling said at least one solution-provider users seeking to Leverage said at least one embodiment of said IP archetypes implemented by at least one solution provider;
b. a second set of procedures for confirming and documenting an agreement by said at least one solution-provider users to terms and conditions provided by said solution-provider tier computing platform;
c. a third set of procedures for incorporating applicable terms and conditions into said at least one solution-provider tier computing platform prior to providing any of said at least one solution-provider users access to Leverage of said at least one embodiment of said IP archetypes implemented by said at least one solution provider; and
d. a fourth set of procedures for managing said solution-provider tier computing platform.

11. The system for monetizing IP archetypes created by at least one innovator, as provided in claim 8, further comprising a master-tier computing platform that comprises at least one computer server executing non-transitory machine-readable code undertaking the steps of:
a. a first set of procedures for registering and enrolling said at least one innovators seeking to offer at least one embodiment of said IP archetypes to said at least one Leveraging Entity seeking to Leverage at least one embodiment of said at least one IP archetypes;
b. a second set of procedures for confirming and documenting an agreement by said at least one innovators to set of terms and conditions by said master-tier computing platform;
c. a third set of procedures for managing said master-tier computing platform; and
d. a fourth set of procedures for accounting between said master-tier computing platform and said innovator-tier computing platform for said distributing and collecting of said first and second plurality of cryptographic tokens.

12. The system for monetizing IP archetypes created by at least one innovator, as provided in claim 8, further comprising a fourth set of procedures for managing said innovator-tier computing platform comprising at least one of: registering said at least one Leveraging Entity seeking to Leverage said at least one embodiment of said IP archetypes; enrolling said at least one Leveraging Entity seeking to Leverage said at least one embodiment of said IP archetypes; vetting said at least one Leveraging Entity seeking to Leverage said at least one embodiment of said IP archetypes; generating said cryptographic tokens for use in exchange for Leveraging said at least one embodiment of said IP archetypes; collecting said cryptographic tokens from said at least one Leveraging Entity Leveraging said at least one embodiment of said IP archetypes; and maintaining an accounting of cryptographic tokens issued and received in return for Leveraging said at least one embodiment of said IP archetypes.

13. The system for monetizing IP archetypes created by at least one innovator, as provided in claim 10, wherein said fourth set of procedures for managing said solution-provider tier computing platform comprises at least one of registering said at least one Leveraging Entity seeking to Leverage said at least one embodiment of said IP archetypes; enrolling said at least one Leveraging Entity seeking to Leverage said at least one embodiment of said IP archetypes; vetting said at least one Leveraging Entity seeking to Leverage said at least one embodiment of said IP archetypes; and maintaining an accounting of payments received and issued in return for Leveraging said at least one embodiment of said IP archetypes.

14. The system for monetizing IP archetypes created by at least one innovator, as provided in claim 11, wherein said third set of procedures for managing said master-tier computing platform comprises at least one of: registering said at least one entity seeking to use said master-tier platform; enrolling said at least one entity seeking to use said master-tier platform; vetting said at least one entity seeking to use said master-tier platform; and maintaining an accounting of use of and payments received for use of said master-tier platform.
